(19) United States
(12) Patent Application Publication
(10) Pub. No.: US 2026/0111813 A1
(43) Pub. Date: Apr. 23, 2026

(54) Machine Learning Operations Model for Regulatory Compliance and Balanced Scheduling

(71) Applicant: BrainTrust IQ, LLC, Las Vegas, NV (US)

(72) Inventors: Dennie O. Guy, Crawford, CO (US); Karl V. Muller, Tarrytown, NY (US); Anthony E. Malfa, Las Vegas, NV (US)

(21) Appl. No.: 18/922,241

(22) Filed: Oct. 21, 2024

(51) Int. Cl. G06Q 10/0631

(52) U.S. Cl. CPC G06Q 10/063118

(57) ABSTRACT

Technological improvements are described for automatically generating crew and equipment schedules that are optimized for regulatory compliance and balanced according to goals or policies referred to as balance settings. Example systems and methods include building and maintaining a compliance library of regulations. A machine-learning operations model generates a schedule that complies with regulations and receives input data including a proposed schedule and the priority-weighted balance settings. Then, the operations model, using a set of recursive processes, generates a candidate schedule that is optimized based on the regulations and the balance settings. An auditor confirms the candidate schedule complies with regulations. The auditor evaluates real-time data to flag potential violations and generate compliance notices and compliance reports. The system includes a generative AI model trained using an industry-specific small language model (ISLM) for receiving textual and image data for use by the operations model and for generating responsive messages.

### TECHNICAL FIELD

Examples set forth in the present disclosure relate to machine learning models, generative models, and regulatory compliance. More particularly, but not by way of limitation, the present disclosure describes a machine learning operations model for generating candidate schedules that are optimized to both comply with regulations and satisfy a set of balance settings. Also described is a generative model that interprets commands and generates messages based on an industry-specific small language model.

### BACKGROUND

Machine learning refers to mathematical models that improve incrementally through experience. By processing different input datasets, a machine-learning algorithm can develop improved generalizations about particular datasets; those generalizations can produce an accurate output or solution when processing a new dataset. Broadly speaking, a machine-learning algorithm includes one or more parameters that will adjust or change in response to new experiences, thereby improving the algorithm incrementally; a process similar to learning.

Generative artificial intelligence models interpret commands (prompts) and in response generate messages including text, images, and other forms. Natural language processing is learned through training, usually with a large language model (LLM). LLMs acquire these abilities by learning statistical relationships between and among the words contained in a large corpus of human language in a training data set, during a supervised training process.

### BRIEF DESCRIPTION OF THE DRAWINGS

Features of the various implementations disclosed will be readily understood from the following detailed description, in which reference is made to the appended drawing figures. A reference numeral is used with each element in the description and throughout the several views of the drawings. When a plurality of similar elements is present, a single reference numeral may be assigned to like elements, with an added letter referring to a specific element. When referring to a non-specific one or more elements the letter may be dropped.

The various elements shown in the figures are not drawn to scale unless otherwise indicated. The dimensions of the various elements may be enlarged or reduced in the interest of clarity. The several figures depict one or more implementations and are presented by way of example only and should not be construed as limiting. Included in the drawings are the following figures:

FIG. 1 is a diagram of an example system environment for training, testing, and executing a machine learning model;

FIG. 2 is a flow diagram of an example machine learning operations model and related modules;

FIG. 3 is a flow diagram of an example processing routine executed by the machine learning operations model described herein;

FIG. 4 is a chart showing an example development of weighted values according to an index, using the machine learning operations model described herein;

FIG. 5 is a block diagram of a sample configuration of a machine adapted to implement the method of generating 3D representations of objects in accordance with the systems and methods described herein; and

FIG. 6 is a flow chart listing the steps in an example process of generating compliant schedules and candidate schedules using the machine learning operations model described herein.

### DETAILED DESCRIPTION

Described herein are techniques and systems for generating schedules for crew and equipment, such as airline flight schedules. A machine learning operations model is trained using historical trip data. In use, the operations model generates schedules that comply with regulations and are optimized based on goals or preferences, called balance settings.

Scheduling trips using crew and equipment in a highly regulated industry involves a large number of variables, many of which impact one or more other variables. The operations model described herein uses machine learning methods to model the interdependence between and among the variables associated with scheduling crew and equipment, while ensuring compliance with regulations and adherence to a set of balance settings.

The following detailed description includes systems, methods, techniques, instruction sequences, and computer program products illustrative of examples set forth in the disclosure. Numerous details and examples are included for the purpose of providing a thorough understanding of the disclosed subject matter and its relevant teachings. Those skilled in the relevant art, however, may understand how to apply the relevant teachings without such details. Aspects of the disclosed subject matter are not limited to the specific devices, systems, and methods described because the relevant teachings can be applied or practiced in a variety of ways. The terminology and nomenclature used herein is for the purpose of describing particular aspects only and is not intended to be limiting. In general, well-known instruction instances, protocols, structures, and techniques are not necessarily shown in detail.

The term “connect,” “connected,” “couple,” and “coupled” as used herein refers to any logical, optical, physical, or electrical connection, including a link or the like by which the electrical or magnetic signals produced or supplied by one system element are imparted to another coupled or connected system element. Unless described otherwise, coupled, or connected elements or devices are not necessarily directly connected to one another and may be separated by intermediate components, elements, or communication media, one or more of which may modify, manipulate, or carry the electrical signals. The term “on” means directly supported by an element or indirectly supported by the element through another element integrated into or supported by the element.

Additional objects, advantages and novel features of the examples will be set forth in part in the following description, and in part will become apparent to those skilled in the art upon examination of the following and the accompanying drawings or may be learned by production or operation of the examples. The objects and advantages of the present subject matter may be realized and attained by means of the methodologies, instrumentalities and combinations particularly pointed out in the appended claims.

Although the examples herein are predominantly discussed in the context of air travel, the techniques and systems described herein may be applied to any form of travel that can be scheduled in some way, such as vehicular travel, rail travel, freight transport on land, rail, and sea, and so on. Moreover, the techniques and systems described herein may be suitable for implementation with any type of scheduling service that involves the computer-implemented planning and deployment of personnel and equipment, including personnel scheduling services, maintenance scheduling, fleet management and scheduling support, freight scheduling, regulatory compliance services, logistics and supply chain services, and so on.

Reference now is made in detail to the examples illustrated in the accompanying drawings and discussed below.

Various embodiments of methods, systems, and computer-readable media for automated problem detection for machine learning models are described. Machine learning models may be deployed in production environments and may produce inferences (predictions) based on input data. Using the techniques described herein, the machine learning operations model generates compliant schedules based on a compliance library and evaluates a variety of variables using weighted values to generate a candidate schedule. Using the techniques described herein, the operations model generates candidate schedules automatically and efficiently.

As one skilled in the art will appreciate in light of this disclosure, embodiments may be capable of achieving certain technological improvements in the field of scheduling crew and equipment, including some or all of the following: (1) improving the regulatory compliance of candidate schedules by automatically and efficiently analyzing schedules using a compliance library containing the applicable regulations; (2) improving the optimization of candidate schedules by automatically and efficiently generating balanced schedules according to a set of balance settings; (3) improving the accuracy and timeliness of regulatory compliance and reducing fines by automatically and efficiently generating reports suitable for submission to a regulatory authority; (4) improving the accuracy and timeliness of regulatory notices by automatically and efficiently generating and transmitting regulatory notices to key personnel; (5) improving travel safety and preventing accidents; (6) improving the costs associated with insurance by improving safety and operations; and so on.

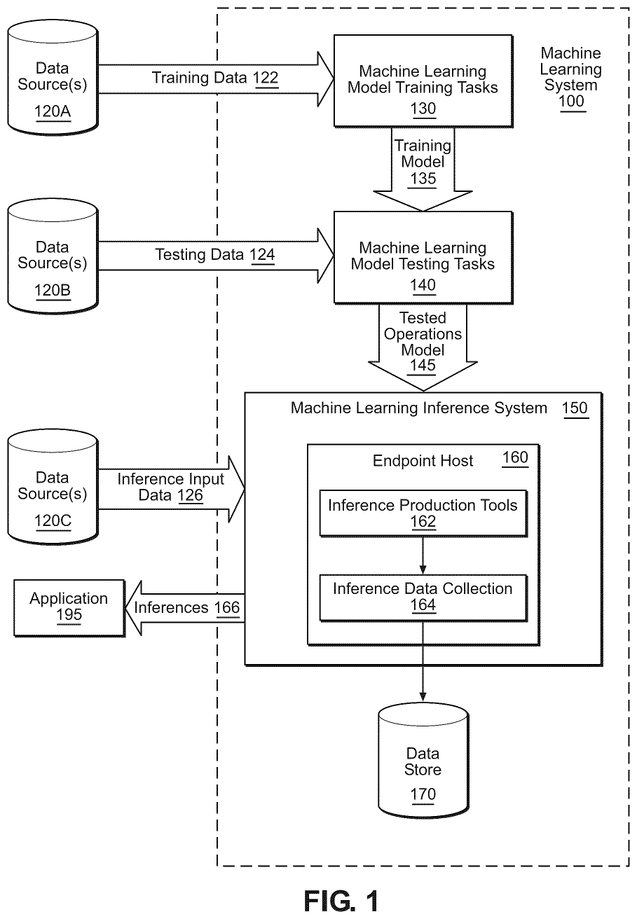

FIG. 1 is a diagram of an example system environment for training, testing, and operating machine learning models, according to some implementations. A machine learning system 100 in some implementations manages the use of one or more machine learning models. A machine learning model in some implementations includes three phases: a training phase during which the model is trained, a testing phase during which the model is tested, and an inference phase during which the model is deployed and applied to live data for the purpose of generating inferences (predictions). In some implementations, the machine learning system 100 includes machine learning model training tasks 130, machine learning model testing tasks 140, and a machine learning inference system 150. The model training tasks 130 in some implementations utilize training data 122 received from one or more data sources 120A for the purpose of producing a trained model 135. The model testing tasks 140 in some implementations test the trained model 135 using testing data 124 received from one or more data sources 120B for the purpose of producing a tested model 145 (e.g., a tested operations model 245 as described herein). The machine learning inference system 150 in some implementations applies the tested model 145 to inference input data 126 from one or more data sources 120C (e.g., real-world or live data) for the purpose of generating predictions known as inferences 166.

In some implementations, a machine learning model may be associated with a collection of weighted values that are trained against a corpus of data, such that the model has learned how to apply those weighted values to classify or interpret a new sample of data. The model training tasks 140 in some implementations include a series of automated processes.

A trained model 145 may be created through an automated process (e.g., model training tasks 140) but may also be constructed by hand in a number of ways, such as by directly implementing code, by computing and manually entering parameterization, and so on. A machine learning model may be accompanied by a ruleset that interprets the model scores. A ruleset may consume a vector of features and produce a new vector.

Data sources 120A, 120B, and 120C in some implementations includes one or more database systems, data stores, tables, repositories, storage services, sources of streaming data, servers, memory locations, and so on.

The training data 122 in some implementations is gathered by users or by automated systems and used as input to an initial machine learning model for the purpose of preparing the model to generate predictions. The training data 122 in some implementations is formatted according to a schema, using a routine called a transformation task to represent raw data according to the schema.

Similarly, the testing data 124 in some implementations is gathered by users or by automated systems and used as input to a trained machine learning model 135 to verify that the model produces correct inferences. The testing data 124 in some implementations is formatted according to the schema.

The inference input data 126 in some implementations represents real-world or live data, which in some implementations is gathered by users or by automated systems, and in some implementations is used as input to the tested machine learning model 145 for the purpose of generating predictions (inferences) about real-world behavior. The inference data 126 in some implementations is formatted according to the schema.

The machine learning model training tasks 130, model testing tasks 140, and the machine learning inference system 150 may be implemented in the same execution environment or in different execution environments. For example, in some implementations, a unified machine learning framework may be used to operate the training tasks 130, the model testing tasks 140, and the machine learning inference system 150 in a hosted environment, on behalf of clients. In some implementations, the training tasks 130 and/or the model testing tasks 140 are performed by clients to produce a tested model 145, and that model 145 may be used to produce inferences in a hosted environment on behalf of a client. In some implementations, the training tasks 130 and/or the model testing tasks 140 are performed in a hosted environment on behalf of a client, and the machine learning inference system 150 is be performed in an external environment (e.g., using client-hosted servers or using another machine learning framework). Any of the machine learning model training tasks 130, the model testing tasks 140, and the machine learning inference system 150 may represent individual systems or subsystems that are loosely coupled with or decoupled from one another.

The machine learning inference system 150 in some implementations includes an endpoint host 160 that operates one or more tested models 145 for the purpose of generating inferences 166. In some implementations, an endpoint host 160 includes one or more hosts or servers that perform inference-generating tasks. In some implementations, the inference system 150 includes one or more endpoint hosts that operate largely independent of one another, such that the performance of one endpoint host may not necessarily affect the operation of another endpoint host.

In some implementations, an endpoint host 160 includes one or more inference production tools 162. The inference production tools 162 in some implementations apply a trained and tested machine learning model 145 to inference input data 126 for the purpose of generating inferences 166. The inferences 166 in some implementations are generated in substantially real-time; e.g., with minimal delays after receiving the inference input data 126.

In some implementations, an endpoint host 160 includes one or more components for inference data collection 164. The collected inference data in some implementations includes data associated with the use of a machine learning model to generate inferences. The data collection 164 in some implementations collects inference data such as the input data, the resulting inference, and various elements of model metadata (e.g., a model identifier, a model version identifier, an endpoint identifier, a timestamp, a container identifier, and so on). The data collection 164 in some implementations collects model data artifacts representing intermediate results before a final inference or prediction is generated.

The inference data collection 164 in some implementations stores the collected inference data using a data store 170. The data store 170 (including, in some implementations, one or more particular storage locations, buckets, or accounts within the data store) and other data collection parameter values may be identified or selected by a user associated with the trained model 145 (e.g., when submitting a request to create an endpoint host 160).

The data store 170 in some implementations is external to the endpoint host 160. For example, the data store 170 may represent a storage service of a provider network, and the inference data may be written to a particular storage location (or set of locations) which are associated with a particular tested model 145. By decoupling the data store 170 from the endpoint host 160, the inference data collection 164 in some implementations generates less impact on the latency of the inference production tools 162. The endpoint host 160 in some implementations collects the inference data in batches and writes it to the data store 170 periodically. The inference data in some implementations is collected during particular time windows (e.g., a one-hour period or a twenty-four-hour period) such that the inference data for one window of time is collected in one chunk of data in the data store 170 while the inference data for another window of time is collected in another chunk of data in the data store 170.

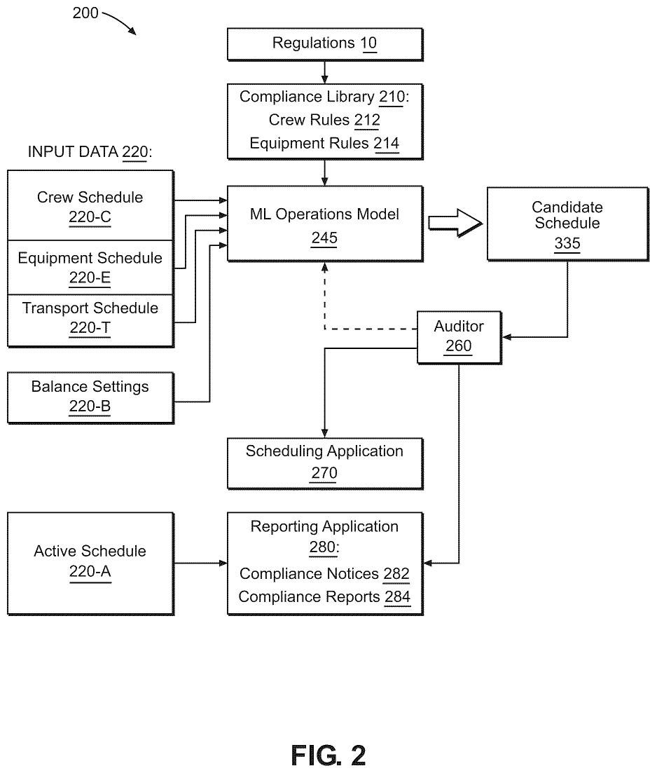

FIG. 2 is a flow diagram 200 of an example machine learning operations model 245 relative to related modules, according to some implementations. FIG. 2 illustrates example processes that may be carried out to perform the techniques described herein. The processes are illustrated as a collection of blocks in a logical flow graph, which represent an example sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like which perform particular functions or implement particular abstract data types. The order in which the operations are described is not intended to be construed as a limitation, and any number of the described blocks can be combined in any order and/or in parallel to implement the processes. Moreover, in some embodiments, one or more blocks of the processes may be omitted entirely.

The compliance library 210 in some implementations includes a set of crew rules 212 and equipment rules 214 based on regulations 10. In the context of airline operations, the regulations 10 may include FAA regulations, DOT compliance rules, state and local government regulations, and international regulations. The DOT regulations include safety rules (FAA, Transportation Security Administration (TSA), and the National Transportation Safety Board (NTSB). The DOT regulations also include consumer protection rules and environmental rules (EPA) related to aircraft operations. The FAA regulations represent a comprehensive framework that covers all aspects of the airline industry, including the airlines (operators or carriers), the equipment (aircraft), the personnel (pilots, flight crew), and flight operations. The Federal Aviation Regulations (FARs) include 14 main parts, including hundreds of sections with discrete rules in each section.

Building the compliance library 210 in some implementations involves selecting a set of applicable regulations that govern a particular industry and then analyzing the text of each regulatory requirement, in the context of the other regulations in the set. The regulations in some implementations are formatted according to a common schema so the data in the compliance library 210 is organized and accessible. The compliance library 210 in some implementations is stored in one or more databases, in a set of relational databases, or in another suitable format.

Maintaining the compliance library 210 in some implementations involves updating the regulations, as stored, when additional regulations are enacted or changed. The compliance library 210 in some implementations includes automated systems or user interfaces for gathering, analyzing, updating, and storing new or amended regulations.

The compliance library 210 in some implementations drives the training and the operation of the machine learning operations model 245 described herein because regulatory compliance is related to nearly all decisions involved in the generation or updating of a flight schedule. Regulatory compliance in general receives the highest priority relative to other considerations.

The input data 220 in some implementations includes a flight schedule and one or more balance settings 220-B. The flight schedule, as shown, in some implementations includes a crew schedule 220-C (e.g., pilot, cockpit crew, cabin crew), an equipment schedule 220-E (e.g., aircraft), and a transport schedule 220-T (e.g., freight and passenger bookings and transportation).

The balance settings 220-B in some implementations include a number of weighted rules, goals, or policies which, unlike regulations, are not mandatory. As described herein, the machine learning operations model 245 optimizes a proposed or candidate flight schedule in accordance with both the compliance library 210 and the balance settings 220-B. For example, the compliance library 210 may includes a federal regulation requiring a minimum of two pilots on a particular aircraft type. The balance settings 220-B may include a policy or preference of scheduling three pilots on the particular aircraft. In this example, the operations model 245 would always staff that particular aircraft with at least two pilots (to comply with regulations) and would sometimes staff that particular aircraft with three pilots. The three-pilot crew is assigned ‘sometimes’ because the balance settings 220-B in some implementations include a weighted priority assigned to each policy or preference. For example, the three-pilot policy may be associated with a relatively high weighted priority (e.g., requiring three pilots on at least 80% of the flights involving that particular aircraft) or a relatively low priority (e.g., requiring three pilots at least 30% of the time).

Building the balance settings 220-B in some implementations involves selecting a set of preferences based on policies (e.g., air carrier standards or internal policies) and analyzing the text of each policy. The balance settings 220-B in some implementations are formatted according to a common schema so the stored data describing the balance settings 220-B is organized and accessible. The set of balance settings 220-B in some implementations is stored in one or more databases, in a set of relational databases, or in another suitable format.

Maintaining the set of balance settings 220-B in some implementations involves updating the policies, as stored, when additional policies are developed or changed. The balance settings 220-B in some implementations include automated systems or user interfaces for gathering, analyzing, updating, and storing new or amended policies. For example, the weighted priority assigned to one or more policies in the set of balance settings 220-B in some implementations is adjustable and configurable, allowing the user to adjust the importance of a particular policy under certain circumstances (e.g., particular aircraft, seasonal adjustments, profitability goals, union requirements, customer service goals, and the like).

The optimization between compliance and policies, as performed by the machine learning operations model 245 described herein, allows a user (e.g., a commercial airline, a charter airline, a railroad) to incorporate its goals and policies into the balance settings 220-B without the risk of impacting regulatory compliance as governed by the compliance library 210.

In some existing systems, the scheduling software or dispatcher creates flight schedules that tend to maximize crew hours, maximize aircraft utilization, and maximize profitability without an emphasis on regulatory compliance. Compliance is often the responsibility of the pilot and other flight crew. This inherent tension between the dispatcher and the pilot can lead to compliance violations (e.g., violations that must be reported to the regulatory authority) and, in some cases, serious safety issues and accidents.

Referring again to FIG. 1, the training data 122 in some implementations includes input data 220 about past flight schedules. For example, a commercial carrier in some implementations begins the process of using the machine learning operations model 245 described herein by further training the operations model 245 using past flight schedules and, in some cases, past or existing policies or balance settings 220-B. The operations model 245 is trained on a variety of training data 122 from various data sources 120A; however, the process of further training the operations model 245 using the carrier's own past flight schedules and policies helps to improve the operations model 245 and to make its use more tailored to the particular carrier's practices and policies.

Referring again to FIG. 2, the flow diagram 200 illustrates that the machine learning operations model 245 in some implementations generates a candidate schedule 335, as further described herein.

The auditor 260 in some implementations uses the compliance library 210, performs a final check of the candidate schedule 335 generated by the operations model 245 to confirm regulatory compliance. A detected compliance violation would cause the candidate schedule 335 to be rejected and the operations model 245 would again generate a new candidate schedule 335. This final compliance check by the auditor 260 helps to ensure regulatory compliance for all the schedules generated by the machine learning operations model 245.

If the candidate schedule 335 passes the audit, then the auditor 260 in some implementations transmits the candidate schedule 335 to a scheduling application 270, where it can be incorporated into a final, published schedule. If the scheduling application 270 rejects the candidate schedule 335 due to any new schedule item (e.g., a crew adjustment, an aircraft is not available, a new departure schedule), that new schedule item becomes part of the input data 220 and the processing by the operations model 245 begins again. The new schedule item in some implementations is assigned a weighted value, giving it a relative priority when the operations model 245 again generates another candidate schedule.

The auditor 260 in some implementations is in communication with a reporting application 280, as shown in FIG. 2. The reporting application 280 in some implementations generates compliance notices 282 and compliance reports 284, as described herein.

### Active Operations

During active operations, the reporting application 280 in some implementations receives real-time data from an active schedule 220-A. In this aspect, the reporting application 280 analyzes the active schedule 220-A (crew, equipment, transport) to determine whether to generate a compliance notice 282 or a compliance report 284.

In another aspect, the active schedule 220-A in some implementations includes real-time flight data received from the onboard flight computers and the multi-control display unit (MCDU), and other real-time data such as the OOOI times (out, off, on, in), the weight-on-wheels switch, and equipment notices (e.g., maintenance items). In this aspect, the reporting application 280 automates the collection of the necessary data and then determines whether to generate a compliance notice 282 or a compliance report 284.

The active schedule 220-A in some implementations includes real-time engine data generated by engine sensors, including engine operation times, engine cycles, and other engine parameters. The reporting application 280 in some implementations collects engine data and generates or otherwise facilitates the process of making entries about each engine into a maintenance logbook. For example, an engine maintenance program requires accurate reporting about engine operating time and engine cycle counts every thirty days for each engine in the program. The reporting application 280 in some implementations collects engine data from engines on aircraft within the fleet, and from engines on rental or other aircraft which are not part of the company fleet.

In another aspect, the system 200 in some implementations tracks aircraft maintenance tasks and parts throughout the fleet. The equipment rules 214 in the compliance library 210 include requirements for ground equipment and tooling. Most equipment, including tools (e.g., torque wrenches, scales, testing rigs, pitot static testers, static adapters, altimeter calibration testers) and materials (e.g., resins, epoxies, composite materials) have an expiration date, a tool calibration schedule, and other periodic and mandatory requirements. For example, many tools must be calibrated periodically (e.g., every twelve months, every six months). The system 200 in some implementations collects on-board data and maintenance activities for the purposes of scheduling maintenance tasks and complying with the regulations governing ground equipment, tooling, and related maintenance tasks.

In the context of the machine learning operations model 245 described herein, the tracking of real-time flight data and maintenance tasks (e.g., engine hours, engine maintenance requirements) in some instances will impact the generation of compliant schedules and candidate schedules. For example, the maintenance data may indicate that engine number 2046 on aircraft tail number N-235923 is due for required maintenance at the machine shop (e.g., in Wichita, Kansas) before a certain due date. Based on the equipment rules 214 in the compliance library 210 and the engine data gathered by the system 200, the operations model 245 when processing a schedule for that aircraft may suggest a schedule or a series of flight schedules which include a stopover in Wichita on or before the maintenance due date. This example describes the interdependence of a wide variety of parameters and variables involved in generating schedules. The operations model 245 is trained, tested, and configured to accommodate these variables during processing to generate schedules that satisfy the regulatory requirements.

### Processing Flow

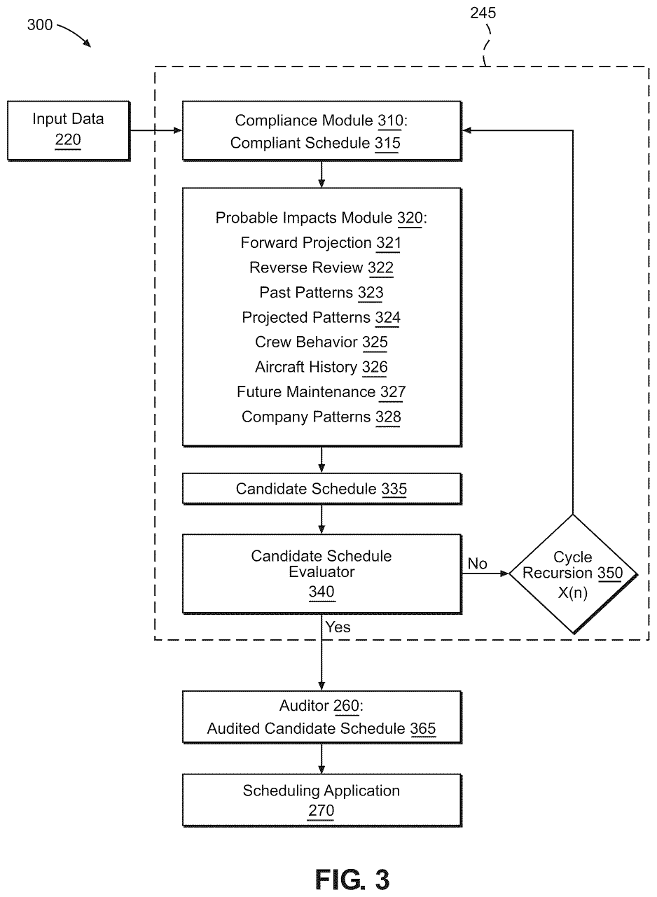

FIG. 3 is a flow diagram 300 including an example processing routine executed by a machine learning operations model 245 according to some implementations. As shown in the example flow diagram 300, the operations model 245 receives input data 220 and is connected to an auditor 260 and a scheduling application 270.

FIG. 3 illustrates example processes that may be carried out to perform the techniques described herein. The processes are illustrated as a collection of blocks in a logical flow graph, which represent an example sequence of operations that can be implemented in hardware, software, or a combination thereof. In the context of software, the blocks represent computer-executable instructions stored on one or more computer-readable storage media that, when executed by one or more processors, perform the recited operations. Generally, computer-executable instructions include routines, programs, objects, components, data structures, and the like which perform particular functions or implement particular abstract data types. The order in which the operations are described is not intended to be construed as a limitation, and any number of the described blocks can be combined in any order and/or in parallel to implement the processes. Moreover, in some embodiments, one or more blocks of the processes may be omitted entirely.

The machine learning operations model 245 may be described as a system operating on a computing device having a display, a processor, and a memory storing instructions.

The machine learning operations model 245 may be any suitable type of machine learning model based on any type or combination of machine learning techniques (e.g., supervised, semi-supervised, unsupervised, reinforcement learning). The machine learning operations model 245 in some implementations utilizes decision trees, random forest, ensembles, probabilistic models, graphical models, neural networks, vector machines, and other algorithms suitable to each task. The machine learning operations model 245 in some implementations applies a variety of computational and statistical approaches, such as clustering, expectation maximization (EM), Bayesian methods and the like.

The machine learning operations model 245 in some implementations includes one or more types of deep learning. Deep learning refers to a class of machine-learning methods that are based on or modeled after artificial neural networks. An artificial neural network is a computing system made up of a number of simple, highly interconnected processing elements (nodes), which process information by their dynamic state response to external inputs. A large artificial neural network might have hundreds or thousands of nodes.

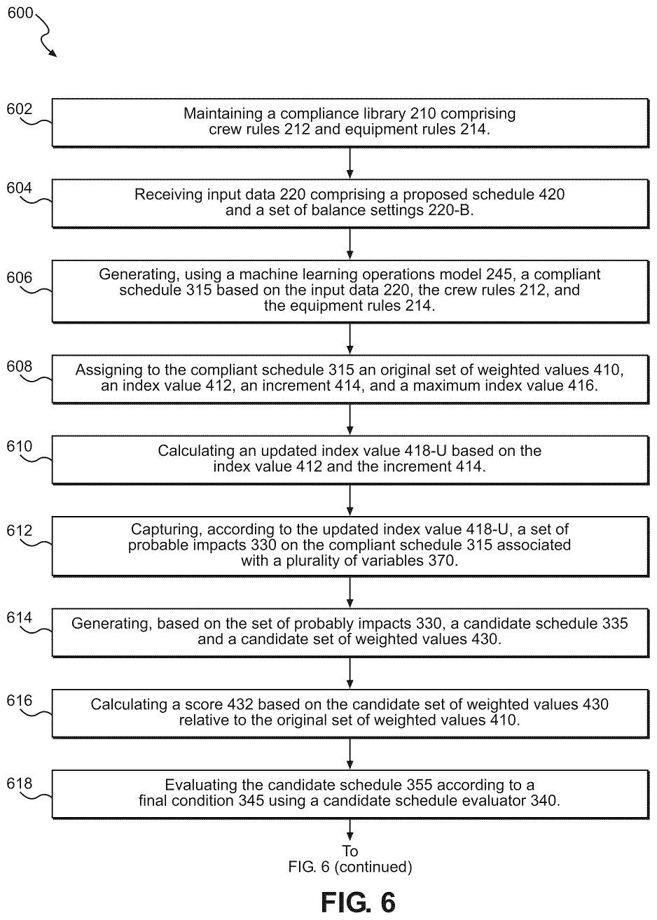

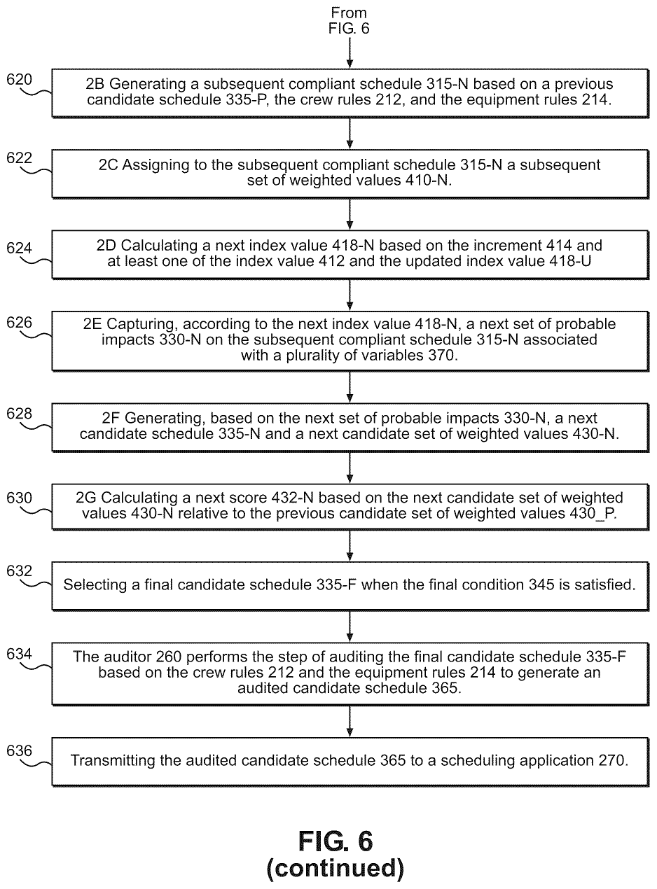

The flow diagram 300 in FIG. 3 is best understood with reference to a flow chart 600 in FIG. 6 that includes a list of example process steps.

FIG. 6 is a flow chart 600 listing the process steps performed by an example system for generating a candidate schedule 335 using the machine learning operations model 245 described herein. Although the process steps are described in the context of generating flight schedules, other uses and implementations of the steps described, for other types of systems, will be understood by one of skill in the art from the description herein. One or more of the process steps shown and described may be performed simultaneously, in a series, in an order other than shown and described, or in conjunction with additional steps. Some process steps may be omitted or, in some applications, repeated.

At block 602, the machine learning operations model 245 performs the example step of maintaining a compliance library 202 comprising crew rules 212 and equipment rules 214. As described herein, the compliance library 202 is built and maintained based on a host of regulations.

At block 604, the machine learning operations model 245 performs the example step of receiving input data 220 (shown in FIG. 3). The input data 220 includes a flight schedule and one or more balance settings 220-B. In some implementations the flight schedule contained in the input data 220 is treated as a proposed schedule 420, or starting point, for processing by the machine learning operations model 245. In this aspect, the proposed schedule 420 in some implementations includes a proposed crew schedule 420-C, a proposed equipment schedule 420-E, and a proposed transport schedule 420-T.

At block 606, the machine learning operations model 245 performs the example step of generating a compliant schedule 315 that is based on the input data 220, the crew rules 212, and the equipment rules 214. As shown in FIG. 3, the step of generating a compliant schedule 315 may be performed by a compliance module 310.

At block 608, the machine learning operations model 245 performs the example step of assigning to the compliant schedule 315 an original set of weighted values 410, an index value 412, an increment 414 associated with the index value 412, and a maximum index value 416.

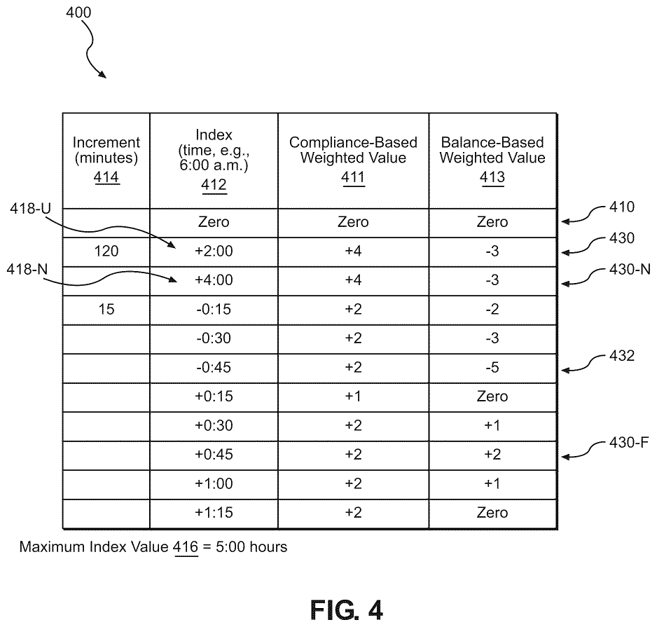

An example of the weighted values is shown in FIG. 4. The set of weighted values in some implementations includes a compliance-based weighted value 411 and a balance-based weighted value 413.

The compliance-based weighted value 411 in some implementations represents a measure of how well a schedule satisfies the crew rules 212 and equipment rules 214 stored in the compliance library 210. The compliance-based weighted value 411 in some implementations is generated in the compliance module 310 (shown in FIG. 3) The balance-based weighted value 413 in some implementations represents a measure of how well a schedule satisfies the balance settings 220-B described herein. As shown in FIG. 2, the balance settings 220-B are part of the input data 220 received by the operation model 245 at block 604.

As described herein, the compliance-based weighted value 411 and the balance-based weighted value 413 in some implementations are used to generate a score 432 associated with each iteration. The score 432 in some implementations represents an evaluation of both weighted values 411, 413. For example, the values 411, 413 may be added together to generate a score 432. In some implementations one or more of the values 411, 413 is assigned a priority or relative weight, such that the generated score 432 reflects the relative weights.

At block 610, the machine learning operations model 245 performs the example step of calculating an updated index value 418-U based on the index value 212 and the increment 414. The updated index value 418-U in some implementations is equal to the starting index value 212 plus or minus the increment 414.

At block 612, the machine learning operations model 245 performs the example step of capturing, according to the updated index value 418-U, a set of probable impacts 330 on the compliant schedule 315 associated with a plurality of variables 370.

### Trip Variables

Scheduling trips using crew and equipment in a highly regulated industry involves a large number of variables, many of which are interdependent (e.g., one variable impacts one or more other variables). The operations model 245 described herein uses machine learning methods to model the interdependence between and among the variables 370 while ensuring compliance with regulations and adherence to a set of balance settings.

In the context of flight operations, the machine learning operations model 245 is trained, tested, and configured to model the interdependencies between and among a plurality of variables 370, to make predictions based on the modeled interdependences, and to generate candidate schedules based on those predictions. The variables 370 include but are not limited to crew factors, equipment factors, operations factors, and the patterns (past and future) associated with each.

The crew factors include but are not limited to hiring, firing, sickness, vacation, training certification, medical qualification and certification, training leave, and all the variety of personnel issues associated with managing human resources. Crew factors also include crew behavior (in general, relative to other crew members, and relative to equipment).

The equipment factors include but are not limited to airworthiness, regulatory certification, new aircraft, retired aircraft, unscheduled maintenance issues, maintenance history (past and future), scheduled maintenance (e.g., based on actual usage, such as the number of cycles before preventive maintenance is required), and all the variety of factors associated with managing a fleet of equipment.

As described at block 612 of FIG. 6, the machine learning operations model 245 is trained, tested, and configured to capture a set probable impacts 330 associated with a plurality of variables 370. The set probable impacts 330 are analyzed relative to their potential impact on a proposed schedule, a compliant schedule 315 generated by the model 245, a candidate schedule 335 generated by the model 245, or an active schedule 220-A (e.g., crew members actively working, aircraft in active service (in flight, on the ground, in maintenance facilities, and the like) or scheduled to enter active service.

As shown in FIG. 3, the machine learning operations model 245 in some implementations captures the set of probable impacts 330 using a probable impacts module 320. The probable impacts module 320 in some implementations includes one or more tools configured to analyze the plurality of variables 370. For example, the probable impacts module 320 in some implementations includes tools for generating and analyzing a forward projection 321 and a reverse review 322; tools for analyzing past patterns 323 and projected patters 324; and tools for analyzing crew behavior 325, aircraft history 326, future maintenance 327, and company patterns 328.

The tools for generating and analyzing a forward projection 321 (future) or a reverse review 322 (data) in some implementations include an analysis, by the operations model 245, of trends in the data (e.g., increasing or decreasing values) associated with (1) one or more of the plurality of variables 370, relative to past values or relative to other variables (e.g., trends between and among pairs or other groupings of variables), and/or (2) one or more of the set of probable impacts 330, relative to past impact value or relative to other impact values (e.g., trends between and among pairs or other groupings of probable impacts).

Similarly, the tools for generating and analyzing past patterns 323 (past) or projected patterns 324 (future) in some implementations include an analysis, by the operations model 245, of patterns in the data (e.g., cyclic values, periodic variations, episodic variations) associated with (1) one or more of the plurality of variables 370, relative to past values or relative to other variables (e.g., trends between and among pairs or other groupings of variables), and/or (2) one or more of the set of probable impacts 330, relative to past impact value or relative to other impact values (e.g., trends between and among pairs or other groupings of probable impacts).

The tool for analyzing crew behavior 325 in some implementations includes an analysis, by the operations model 245, of past and current crew behavior, including but not limited to scheduled sick leave, family and medical leave, unscheduled sick leave, vacation, certifications, medical qualifications, training, interpersonal relationships (e.g., conflicts or reports associated with other crew or passengers), discipline (e.g., regulatory violations, reprimands), interactions with equipment (e.g., difficulty with certain aircraft types), and the like.

The tool for analyzing aircraft history 326 in some implementations includes an analysis, by the operations model 245, of past and current aircraft factors, including but not limited to unscheduled maintenance issues, scheduled maintenance (e.g., based on regulations or based on sensors associated with each component), real-time flight data (e.g., OOOI times, weight-on-wheel switch, engine performance, avionics data), and the like.

The tool for analyzing future maintenance 327 in some implementations includes an analysis, by the operations model 245, of past and current maintenance issues, including but not limited to unscheduled maintenance, scheduled maintenance (e.g., mandated by regulation, based on hours in service or a number of cycles), expected or anticipated maintenance issues (e.g., a maintenance item approaching the time when service will be required), and unscheduled maintenance issues (e.g., based on onboard sensors, flight data, engine performance), and the like.

As described herein, the system 200 in some implementations collects real-time aircraft data related to maintenance, engine performance, tools, tasks, and parts throughout the fleet. The equipment rules 214 in the compliance library 210 include requirements for engines, ground equipment, and tools. The tool for analyzing future maintenance 327 in some implementations uses the data collected from aircraft and the equipment rules 214 to analyze the maintenance needs of each engine, part, and aircraft in the fleet. The future maintenance 327 may directly impact the processing and generation of compliant schedules and candidate schedules by the operations model 245. For example, the maintenance data may indicate that engine number 2046 on aircraft tail number N-235923 is due for required maintenance at the machine shop (e.g., in Wichita) before a certain due date. Based on the equipment rules 214 in the compliance library 210 and the engine data gathered by the system 200, the operations model 245 when processing a schedule for that aircraft may suggest a schedule or a series of flight schedules which include a stopover in Wichita on or before the maintenance due date. This example describes the interdependence of the plurality of parameters 370 and related variables involved in generating schedules.

The tool for analyzing company patterns 328 in some implementations includes an analysis, by the operations model 245, of patterns identified in the past and current activity of the company (e.g., a commercial airline, a charter airline). The patterns may be associated with the set of balance settings 220-B, such as the addition, editing, or removal of a setting; changes to the weight or priority associated with each setting; observed relaxation or toughening of certain settings relative to the governing regulations.

Referring again to block 612, the set of probable impacts 330 is generated according to the updated index value 418-U. In some instances, the index 412 is a clock time (e.g., 6:00 a.m.) and the increment 414 is a value measured in minutes (e.g., fifteen minutes). In a basic example, the updated index value 418-U after one increment would be 6:15 a.m. In this example, the set of probable impacts 330 is generated as of 6:15 a.m. according to the predictions and probabilities about the plurality of variables 370.

At block 614, the machine learning operations model 245 performs the example step of generating, based on the set of probable impacts 330, a candidate schedule 315 and a candidate set of weighted values 430. Because the set of probable impacts 330 was evaluated as of the updated index value 418-U (e.g., at 6:15 a.m.), the candidate set of weighted values 430 represents the weighted values associated with the candidate schedule 335 as of the updated index value 418-U (e.g., the weighted values predicted as of 6:15 a.m.)

At block 616, the machine learning operations model 245 performs the example step of calculating a score 432 based on the candidate set of weighted values 430 compared to the original set of weighted values 410. The score 432 represents the predicted, incremental improvement (or deterioration) of the weighted values as the index is incremented (e.g., over time).

At block 618, the machine learning operations model 245 performs the example step of evaluating the candidate schedule 355 according to a final condition 345 using a candidate schedule evaluator 340.

The candidate schedule evaluator 340, as shown in FIG. 3, cooperates in some implementations with a cycle recursion controller 350. If the candidate schedule 335 does not satisfy the final condition 345, then the machine learning operations model 245 in some implementations performs an example process that occurs recursively and iteratively, according to the increment 414, until the final condition 345 is satisfied. In this aspect, the candidate schedule evaluator 340 decision is the beginning of the recursive and iterative processes performed by the machine learning operations model 245.

At block 620, the recursive process includes generating a subsequent compliant schedule 315-N (using the compliance module 310, as shown in FIG. 3). The subsequent compliant schedule 315-N in some implementations is based on a previous candidate schedule 315-P (e.g., from the immediately previous iteration), the crew rules 212, and the equipment rules 214. The previous candidate schedule 315-P is associated with a previous candidate set of weighted values 430-P. In this aspect, the process of generating a compliant schedule is repeated for the purpose of generating a subsequent compliant schedule 315-N for analysis.

The recursive process repeats the process steps described above. With each iteration, the machine learning operations model 245 analyzes a subsequent compliant schedule 315-N.

At block 622, the recursive process includes assigning to the subsequent compliant schedule 315-N a subsequent set of weighted values 410-N. Like the original set of weighted values 410 associated with the first compliant schedule 315, the subsequent set of weighted values 410-N represents a starting condition for each iteration in the recursive process.

The recursive process in some implementations includes the index value 412, the increment 414 associated with the index value 412, and the maximum index value 416, each of which was established in the first iteration of the processing of the input data 220 by the machine learning operations model 245.

At block 624, the recursive process includes calculating a next index value 418-N based on the increment 414 and either the original index value 418 (e.g., set to zero) or the updated index value 418-U (e.g., the index value associated with the immediately previous iteration). The next index value 418-N in some implementations is equal to the updated index value 418-U plus or minus the increment 414.

At block 626, the recursive process includes capturing, according to the next index value 418-N, a next set of probable impacts 330-N on the subsequent compliant schedule 315-N associated with the plurality of variables 370, as determined by using the probable impacts module 320.

At block 628, the recursive process includes generating, based on the next set of probable impacts 330-N, a next candidate schedule 315-N and a next candidate set of weighted values 430-N.

At block 630, the recursive process includes calculating a next score 432-N based on the next set of weighted values 430-N compared to the previous candidate set of weighted values 430-P. The next score 432-N represents the predicted, incremental improvement (or deterioration) of the weighted values as the index is incremented (e.g., over time).

Next, the process described at block 618 would occur again. The machine learning operations model 245 evaluates the next candidate schedule 355-N according to the final condition 345 using the candidate schedule evaluator 340.

If the next candidate schedule 335-N does not satisfy the final condition 345, then the machine learning operations model 245 in some implementations performs the recursive process again and again, according to the increment 414, until the final condition 345 is satisfied.

If the next candidate schedule 335-N satisfies the final condition 345, then at block 632, the recursive process includes selecting a final candidate schedule 335-F. Then, the machine learning operations model 245 performs the example step of transmitting the final candidate schedule 335-F to an auditor 260, as shown in FIG. 3.

At block 634, the auditor 260 performs the example step of auditing the final candidate schedule 335-F based on the crew rules 212 and the equipment rules 214 and generating an audited candidate schedule 365. The auditor 260 in some implementations uses the compliance library 210, performs a final check for regulatory compliance of the final candidate schedule 3350-F that was generated by the recursive process of the operations model 245. A detected compliance violation would cause the final candidate schedule 335-F to be rejected and the operations model 245 would again generate a next compliant schedule 315-N and a next candidate schedule 335-N as described herein.

At block 636, the auditor 260 in some implementations performs the example step of transmitting the audited candidate schedule 365 to a scheduling application 270 (as shown in FIG. 3). The schedule application 270 in some implementations incorporates the audited candidate schedule 365 into a final, published schedule. If the scheduling application 270 rejects the audited candidate schedule 365 due to any new schedule item (e.g., a crew adjustment, an aircraft is not available, a new departure schedule), that new schedule item becomes part of the input data 220 and the processing by the operations model 245 begins again. The new schedule item in some implementations is assigned a weighted value, giving it a relative priority when the operations model 245 again generates another candidate schedule.

FIG. 4 is a chart 400 showing an example development of weighted values according to an index, using the machine learning operations model 245.

Referring briefly to the example process steps in FIG. 6, the process at block 608 includes the step of assigning to the compliant schedule 315 an original set of weighted values 410, an index value 412, an increment 414 associated with the index value 412, and a maximum index value 416. The chart 400 in FIG. 4 shows examples of an index value 412 (e.g., a clock time, such as 6:00 a.m.), an increment 414 (e.g., in minutes), a maximum index value 416 (e.g., a time period, such as five hours), and an original set of weighted values 410 (e.g., starting with zero).

The index value 412, the increment 414, and maximum index value 416 in some implementations are predetermined or default values which are configurable through a user interface or automated processes. In some implementations, the operations model 245 starts with values 412, 414, 416 that are based on the set of balance settings 220-B associated with each parameter (e.g., departure time settings, preferred pilot assignments, crew behavior factors). In some implementations, the operations model 245 starts with values 412, 414, 416 that are based on experience. For example, the operations model 245 through machine learning and experience might start with values 412, 414, 416 which in previous rounds of processing led to the successful result. In some instances, the maximum index value 416 is determined based on a regulation. For example, an assigned pilot may have only three hours of active flight duty remaining. A new flight time beyond this window would result in a compliance violation. In this example, the operations model 245 would use a maximum index value 416 of three hours, to ensure compliance with the regulation.

The original set of weighted values 410 in this example includes a compliance-based weighted value 411 (e.g., set at zero) and a balance-based weighted value 413 (e.g., set at zero). The compliance-based weighted value 411 in some implementations represents a measure of how well a schedule satisfies the crew rules 212 and equipment rules 214. The balance-based weighted value 413 in some implementations represents a measure of how well a schedule satisfies the balance settings 220-B described herein.

The increment 414 is associated with the index value 412. For example, in FIG. 4, the index value 412 represents a time (e.g., a flight departure time) and the increment is a time value (e.g., twenty minutes) such that the index increases by twenty minutes with each iteration.

In another example, an index value 412 may represent an item of equipment (e.g., an aircraft tail number) and the increment may be a numerical value (e.g., three) such that the index increases by three tail numbers. In accordance with the index, the operations model 245 selects from a list of aircraft tail numbers, for each iteration, every third tail number for processing.

The increment 414 in some implementations is a variable, adjusted by the operations model 245 during processing. For example, in FIG. 4, the first increment 414 is 120 minutes. The increment 414 later adjusts to 15 minutes. In some implementations the operations model 245 adjusts the increment 414 in response to trends detected in the sets of weighted values produced, as described herein.

Referring again to the example process steps in FIG. 6, the process at block 610 includes the step of calculating an updated index value 418-U based on the index value 212 and the increment 414. The updated index value 418-U in some implementations is equal to the starting index value 212 plus or minus the increment 414. For example, in FIG. 4, the updated index value 418-U (e.g., +2:00 hours) is based on the starting index value 212 (e.g., zero) plus the increment 414 (e.g., 120 minutes).

The process at block 614 includes the step of generating a candidate schedule 315 and a candidate set of weighted values 430. For example, in FIG. 4, the candidate set of weighted values 430 includes a compliance-based weighted value 411 (e.g., +4) and a balance-based weighted value 413 (e.g., −3). The set of weighted values 411, 413 as of the index value 412 (e.g., +2:00 hours) may be expressed as {+4, −3}. The weighted values 411, 413 in some implementations are used to generate a next score 432-N associated with each iteration.

At the next iteration, as shown in FIG. 4, the next index value 418-N (e.g., +4:00 hours) is based on the immediately previous index value (e.g., the updated index value 418-U, +2:00 hours) plus the increment (e.g., 120 minutes). The next candidate set of weighted values 430-N includes a compliance-based weighted value 411 (e.g., +4) and a balance-based weighted value 413 (e.g., −3). The set of weighted values 411, 413 as of the next index value 418-N (e.g., +4:00 hours) may be expressed as {+4, −3}. The set of weighted values 411, 413 in some implementations are used to generate a next score 432-N associated with each iteration.

At the next iteration, as shown in FIG. 4, the next index value cannot be set to +6:00 hours because the index values are limited by the maximum index value 416 (e.g., 5:00 hours). In this example, the operations model 245 changes the increment 414 (e.g., from 120 minutes to fifteen minutes) as shown in FIG. 4. The operations model 245 in some implementations is configured to change the increment 414 in response to the maximum index value 416, as shown in the example. Also, the operations model 245 in some implementations is configured to change the increment 414 in response to detecting a trend in the data, as described herein.

For the next iteration, shown in FIG. 4, the increment 414 has changed from 120 minutes to 15 minutes. In this example, the next index value 418-N is negative fifteen minutes (−0: 15) which is equal to the starting index value 212 (e.g., zero) minus the new increment 414 (e.g., fifteen minutes). In this aspect, the next index value 418-N may be calculated based on the increment 414 and either (a) the original index value 412 (e.g., set to zero) or (b) the updated index value 418-U (e.g. the index value associated with the immediately previous iteration). For example, in FIG. 4, the next index value 418-N (e.g., +4:00 hours) was based on the immediately previous index value (e.g., +2:00 hours) plus the increment (e.g., 120 minutes). After the increment is changed to fifteen minutes, the next index value (e.g., −0:15) is based on the original index value 412 (e.g., set to zero) minus the increment (e.g., fifteen minutes).

The next candidate set of weighted values associated with the next index value (e.g., −0:15) includes a compliance-based weighted value 411 (e.g., +2 and a balance-based weighted value 413 (e.g., −2). The set of weighted values 411, 413 as of this next index value hours may be expressed as {+2, −2}.

For the next iteration, shown in FIG. 4, the next candidate set of weighted values associated with the next index value (e.g., −0:30) includes a compliance-based weighted value 411 (e.g., +2 and a balance-based weighted value 413 (e.g., −3). In this example, the next index value (e.g., −0:30) is based on the increment (e.g., 15 minutes) and the immediately previous index value (e.g., −0:15).

For the next iteration, shown in FIG. 4, the next candidate set of weighted values associated with the next index value (e.g., −0:45) includes a compliance-based weighted value 411 (e.g., +2 and a balance-based weighted value 413 (e.g., −5).

The operations model 245 in some implementations is trained, tested, and configured to detect trends in the weighted values (and in a variety of other generated values).

For example, the iterations in FIG. 4 show a trend 432 in the balance-based weighted values 413 (e.g., progressively decreasing from −2 to −3 and then to −5 associated with the index value of 0:45. In some implementations the operations model 245 is configured to change the increment 414 (e.g., from fifteen minutes to another value) and/or change the calculation of the next index value (e.g., by adding the increment instead of subtracting). For example, the next iteration in FIG. 4 represents the same increment (e.g., fifteen minutes) and a new calculation (e.g., the next index value (+0:15) is based on the original index value (e.g. set to zero) plus the increment.

For the next iterations, shown in FIG. 4, each of the next index values (e.g., +0:30, +0:45, +1:00, +1:15) is based on the immediately previous index value plus the increment.

The operations model 245 in some implementations is trained, tested, and configured to detect the preferred, best, or final set of weighted values 430-F (e.g., the values {+2, +2} associated with the index value of +0:45). The operations model 245 in some implementations uses the score 432 associated with each iteration to identify the final set of weighted values 430-F. In other implementations, the operations model 245 compares the set of weighted values associated with one or more previous iterations and/or one or more future iterations, and based on that comparison, identifies the best or final set of weighted values 430-F.

The final candidate schedule 335-F is selected when a final condition 345 is satisfied. The final condition 345 in some implementations is satisfied when either (1) the next score calculated during the recursive processes approaches an extreme (e.g., a maximum, a minimum) relative to one or more previous scores, or (2) when the index value 412 reaches or exceeds the maximum index value 416. The final set of weighted values 430-F is associated with a final candidate schedule 335-F but not always. For example, if the final condition 345 includes only a best departure time (and no other factors) then, in FIG. 4, the identification of the final set of weighted values 430-F associated with an index time of +0:45 would indicate that the final candidate schedule 335-F includes a departure time that is 45 minutes later than the departure time contained in the input data 220.

In a related aspect, the operations model 245 in some implementations identifies a final candidate schedule 335-F when the recursive processing, iteratively by index value 412, reaches the maximum index value 416. For the example index values shown in FIG. 4 (e.g., +0:30, +0:45, +1:00, +1:15, etc.) the recursive processing may continue until the index value equals or, if iterated again, would exceed the maximum index value 416 (e.g., 5:00 hours).

More often, however, the final condition 345 includes a variety of factors (e.g., crew availability, aircraft maintenance, pilot rest requirements, etc.) and the machine learning operations model 245 in some implementations processes each factor - by and through executing all the process steps, including the recursive processes, for each factor - and identifies a final set of weighted values 430-F associated with each factor. In this aspect, the operations model 245 in some implementations generates a collection or superset of final sets of weighted values 430-F. By comparing all the sets of weighted values 430-F in the superset, the operations model 245 selects the final candidate schedule 335-F.

However, in another aspect, each one of the factors will have some impact on the other factors. For example, the recursive processes associated with crew (e.g., assigning a pilot to a flight) and/or equipment (e.g., assigning an aircraft) will typically have an impact on the recursive process associated with a time (e.g., selecting a departure time). For example, suppose a final set of weighted values 430-F is associated with an index time of +0:45. This would suggest the best departure time that is forty-five minutes later than the input data 220. However, suppose a final set of weighted values 430-F is associated with an index value for a particular pilot (e.g., index value 127 for pilot Anderson). If the departure time of +0:45 would exceed the regulatory maximum flight duty time for pilot 127, then assigning pilot 127 would cause a compliance violation. In this instance, the operations model 245 would execute the recursive processes again - until the final sets of weighted values 430-F identify a combination of departure time and pilot assignment which complies with regulations. Also, in another aspect, because the final sets of weighted values 430-F include a balanced-based weighted value, the final combination of departure time and pilot assignment needs to comply with the balance settings 220-B as described herein.

In this aspect, the operations model 245 in some implementations is trained, tested, and configured to process data in accordance with both the compliance library 210 and the balance settings 220-B. For example, processing may generate a possible candidate schedule that complies with regulations 10 but is a poor solution relative to the balance settings 220-B. Conversely, processing may generate a possible candidate schedule that meets the balance settings 220-B, but is a poor solution relative to the regulations 10.

For example, the processing may generate a possible candidate schedule that complies with regulations 10 (e.g., a pilot duty time of 7.8 hours is compliant) but is a poor solution relative to the balance settings 220-B (e.g., a target pilot duty time of no more than 6.0 hours).

First, the operations model 245 in some implementations is configured to reject or disfavor a solution that includes a factor that exceeds a balance setting value (e.g., 6.0 hours) by more than a threshold value (e.g., more than 1.5 hours). For example, the balance settings 220-B may include a target pilot duty time (e.g., 6.0 hours), a threshold value (e.g., 1.5 hours), and a priority assigned to the pilot duty time (e.g., the pilot duty time limit of 6.0 hours must be satisfied in at least 80% of a pilot's flight assignments in any calendar month). If this balance setting is not satisfied, then the operations model 245 is configured to reject that solution and continue processing and generating alternatives.

Also, the pilot duty time of 7.8 hours is very close the regulatory limit of 8 hours for a flight crew consisting of one pilot. Although compliance is satisfied, the operations model 245 in some implementations is configured to detect the proximity of a solution relative to the regulatory compliance limit (e.g., 7.8 hours is within a threshold proximity (e.g., 1 hour) relative to the maximum duty time of 8.0 hours). The threshold proximity in some implementations is part of the compliance library 210 (e.g., a proximity associated with one of more crew rules 212 and one or more equipment rules 214) or, in some implementations, is part of the balance settings 220-B. The threshold proximity in some implementations includes a crew rule (e. g, pilot duty time), a threshold value (e.g., 30 minutes), and a priority assigned to the crew rule (e.g., the pilot duty time must not be within the threshold value of the regulatory maximum more than 25% of the flights during a calendar quarter). If this balance setting is not satisfied, then the operations model 245 is configured to reject that solution and continue processing and generating alternatives.

### User Interface

In use, the operations model 245 and related modules in some implementations include a user interface (e.g., installed on a portable wireless device) for capturing data, receiving voice or text input, and delivering messages.

The user interface in some implementations includes an image processing module (e.g., installed on a portable wireless device) for processing images captured by a camera. For example, the camera of a portable wireless device may be used to capture an image of onboard avionics equipment, settings, or displays, such as the display of an MCDU (Multi-purpose Control and Display Unit). In some implementations, the image data captured by a camera is processed using the generative artificial-intelligence model described herein.

The user interface in some implementations includes a text module through which users may enter text queries, commands, or updates (e.g., about crew, equipment, or operations). The text module in some implementations includes a voice recognition and processing module for translating human speech into useful text.

The user interface in some implementations includes and operates using a generative artificial-intelligence model for interpreting commands and generating messages.

Instead of a large language model, the generative model in some implementations is trained using an industry-specific small language model (ISLM). As used herein, the ISLM means and includes a computational model designed for tasks related to natural language processing in a specific field or industry. An ISLM acquires its interpretation and generation abilities by learning statistical relationships between and among the words contained in an industry-specific corpus of human language which is limited to the words and phrases typically encountered in that particular industry. In some implementations, the generative model is further trained using a corpus of industry-specific image data.

In the context of flight operations, industry-specific corpus of human language used for training may be limited to the words and other indicia typically encountered in the field of aviation. Such indicia for training may include words, definitions, terms of art, aliases, jargon, slang, abbreviations, acronyms, phrases, icons, numbers, and other types of symbols related to aviation.

When trained using the ISLM, the generative model would be prepared to recognize text of voice commands that include industry jargon, acronyms, slang, and the like.

Training using the ISLM instead of a large language model, in some implementations, would improve efficiency and accuracy because the dictionary is specifically tailored to the industry.

The system 200 described herein in some implementations includes a user interface for receiving a textual input, such as a text message or a voice command. The process of receiving input data 220 (block 604) in some implementations includes processing the textual input using the generative artificial-intelligence model, such that the input data 220 to be processed by the machine learning operations model 245 includes one or more items of data based on the textual input. In turn, the process of generating a compliant schedule 315 would, at least in part, be based on the textual input. In this aspect, a user can add to the input data 220 by entering a text message or speaking a voice command.

The system 200 described herein in some implementations includes a user interface for receiving a image input, such as image data (e.g., still images or video) captured by a camera. The process of receiving input data 220 (block 604) in some implementations includes processing the image input using the generative artificial-intelligence model, such that the input data 220 to be processed by the machine learning operations model 245 includes one or more items of mage data based on the image input. In turn, the process of generating a compliant schedule 315 would, at least in part, be based on the image input. In this aspect, a user can add to the input data 220 by taking a photograph (e.g., taking a screen shot of the MCDU display in the cockpit).

The generative model in some implementations includes an automated process or a user-involved procedure for understanding messages or commands that contain a new word or phrase. In this aspect, the generative model improves over time as new terms are learned.

The generative model in some implementations includes a message generation component for generating text or voice messages to personnel which, because of the ISLM, will be composed using the industry-specific words and phrases in the dictionary. The system described herein in some implementations includes a process for searching the audited candidate schedule 365 for one or more items of information which are responsive to the textual input. In turn, the generative artificial-intelligence model performs the process of generating a message that includes the one or more items of responsive information.

### Computing Devices

Techniques described herein may be used with one or more of the computing systems described herein or with one or more other systems. For example, the various procedures described herein may be implemented with hardware or software, or a combination of both. For example, at least one of the processor, memory, storage, output device(s), input device(s), or communication connections discussed below can each be at least a portion of one or more hardware components. Dedicated hardware logic components can be constructed to implement at least a portion of one or more of the techniques described herein. For example, and without limitation, such hardware logic components may include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc. Applications that may include the apparatus and systems of various aspects can broadly include a variety of electronic and computing systems. Techniques may be implemented using two or more specific interconnected hardware modules or devices with related control and data signals that can be communicated between and through the modules, or as portions of an application-specific integrated circuit. Additionally, the techniques described herein may be implemented by software programs executable by a computing system. As an example, implementations can include distributed processing, component/object distributed processing, and parallel processing. Moreover, virtual computing system processing can be constructed to implement one or more of the techniques or functionalities, as described herein.

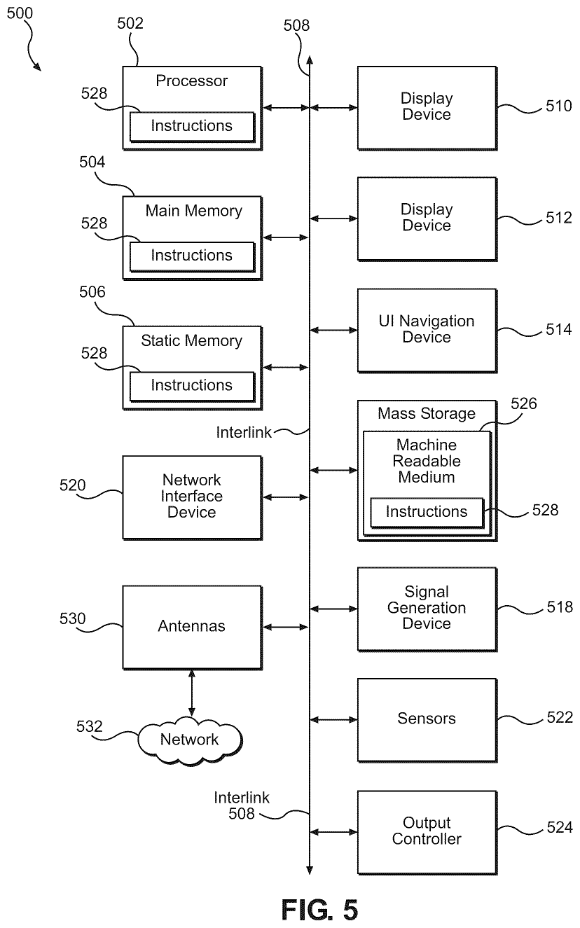

FIG. 5 illustrates an example configuration of a machine 500 including components that may be incorporated into the processor 502 adapted to manage the 3D asset construction.

In particular, FIG. 5 illustrates a block diagram of an example of a machine 500 upon which one or more configurations may be implemented. In alternative configurations, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. In sample configurations, the machine 500 may be a personal computer (PC), a tablet PC, a set-top box (STB), a personal digital assistant (PDA), a mobile telephone, a smart phone, a web appliance, a server, a network router, switch or bridge, or any machine capable of executing instructions (sequential or otherwise) that specify actions to be taken by that machine. For example, machine 500 may serve as a workstation, a front-end server, or a back-end server of a communication system. Machine 500 may implement the methods described herein by running the software used to implement the features described herein. Further, while only a single machine 500 is illustrated, the term “machine” shall also be taken to include any collection of machines that individually or jointly execute a set (or multiple sets) of instructions to perform any one or more of the methodologies discussed herein.

Examples, as described herein, may include, or may operate on, processors, logic, or a number of components, modules, or mechanisms (herein “modules”). Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computing systems (e.g., a standalone, client or server computer system) or one or more hardware processors may be configured by firmware or software (e.g., instructions, an application portion, or an application) as a module that operates to perform specified operations. In an example, the software may reside on a machine-readable medium. The software, when executed by the underlying hardware of the module, causes the hardware to perform the specified operations.

Accordingly, the term “module” is understood to encompass at least one of a tangible hardware or software entity, be that an entity that is physically constructed, specifically configured (e.g., hardwired), or temporarily (e.g., transitorily) configured (e.g., programmed) to operate in a specified manner or to perform part or all of any operation described herein.

Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computing system or processor) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510 (shown as a video display), an alphanumeric input device 512 (e.g., a keyboard), and a user interface (UI) navigation device 514 (e.g., a mouse). In an example, the display unit 510, input device 512 and UI navigation device 514 may be a touch screen display. The machine 500 may additionally include a mass storage device (e.g., drive unit) 516, a signal generation device 518 (e.g., a speaker), a network interface device 520, and one or more sensors 522. Example sensors 522 include one or more of a global positioning system (GPS) sensor, compass, accelerometer, temperature, light, camera, video camera, sensors of physical states or positions, pressure sensors, fingerprint sensors, retina scanners, or other sensors. The machine 500 may include an output controller 524, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The mass storage device 516 may include a machine readable medium 526 on which is stored one or more sets of data structures or instructions 528 (e.g., software) embodying or utilized by any one or more of the techniques or functions described herein. The instructions 528 may also reside, completely or at least partially, within the main memory 504, within static memory 506, or within the hardware processor 502 during execution thereof by the machine 500. In an example, one or any combination of the hardware processor 502, the main memory 504, the static memory 506, or the mass storage device 516 may constitute machine readable media.

While the machine readable medium 526 is illustrated as a single medium, the term “machine readable medium” may include a single medium or multiple media (e.g., at least one of a centralized or distributed database, or associated caches and servers) configured to store the one or more instructions 528. The term “machine readable medium” may include any medium that is capable of storing, encoding, or carrying instructions for execution by the machine 500 and that cause the machine 500 to perform any one or more of the techniques of the present disclosure, or that is capable of storing, encoding, or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine-readable media. In some examples, machine readable media may include machine readable media that is not a transitory propagating signal.

The instructions 528 may further be transmitted or received over communications network 532 using a transmission medium via the network interface device 520. The machine 500 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as WI-FI®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 520 may include one or more physical jacks (e.g., Ethernet, coaxial, or phone jacks) or one or more antennas 530 to connect to the communications network 532. In an example, the network interface device 520 may include a plurality of antennas 530 to wirelessly communicate using at least one of single-input multiple-output (SIMO), multiple-input multiple-output (MIMO), or multiple-input single-output (MISO) techniques. In some examples, the network interface device 520 may wirelessly communicate using Multiple User MIMO techniques.

The features and flowcharts described herein can be embodied in one or more methods as method steps or in one or more applications as described previously. According to some configurations, an “application” or “applications” are program(s) that execute functions defined in the programs. Various programming languages can be employed to generate one or more of the applications, structured in a variety of manners, such as object-oriented programming languages (e.g., Objective-C, Java, or C++) or procedural programming languages (e.g., C or assembly language). In a specific example, a third-party application (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application can invoke API calls provided by the operating system to facilitate the functionality described herein. The applications can be stored in any type of computer readable medium or computer storage device and be executed by one or more general purpose computers. In addition, the methods and processes disclosed herein can alternatively be embodied in specialized computer hardware or an application specific integrated circuit (ASIC), field programmable gate array (FPGA) or a complex programmable logic device (CPLD).

Program aspects of the technology may be thought of as “products” or “articles of manufacture” typically in the form of at least one of executable code or associated data that is carried on or embodied in a type of machine-readable medium. For example, programming code could include code for the touch sensor or other functions described herein. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from the server system or host computer of a service provider into the computer platforms of the smartwatch or other portable electronic devices. Thus, another type of media that may bear the programming, media content or metadata files includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to “non-transitory,” “tangible,” or “storage” media, terms such as computer or machine “readable medium” refer to any medium that participates in providing instructions or data to a processor for execution.

Hence, a machine-readable medium may take many forms of tangible storage medium. Non-volatile storage media include, for example, optical or magnetic disks, such as any of the storage devices in any computer(s) or the like, such as may be used to implement the client device, media gateway, transcoder, etc. shown in the drawings. Volatile storage media include dynamic memory, such as main memory of such a computer platform. Tangible transmission media include coaxial cables; copper wire and fiber optics, including the wires that comprise a bus within a computing system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer may read at least one of programming code or data. Many of these forms of computer readable media may be involved in carrying one or more sequences of one or more instructions to a processor for execution.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

In addition, in the foregoing Detailed Description, it can be seen that various features are grouped together in various examples for the purpose of streamlining the disclosure. This method of disclosure is not to be interpreted as reflecting an intention that the claimed examples require more features than are expressly recited in each claim. Rather, as the following claims reflect, the subject matter to be protected lies in less than all features of any single disclosed example. Thus, the following claims are hereby incorporated into the Detailed Description, with each claim standing on its own as a separately claimed subject matter.

While the foregoing has described what are considered to be the best mode and other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present concepts.

What is claimed is:

1. A system for generating a schedule, comprising:
a display;
one or more processors;
a memory storing instructions that when executed by the one or more processors cause the one or more processors to perform a plurality of process steps comprising:
maintaining a compliance library based on a plurality of regulations, wherein the compliance library comprises crew rules and equipment rules;
receiving input data comprising a proposed schedule and a set of balance settings, wherein the proposed schedule comprises a crew schedule, an equipment schedule, and a transport schedule;
generating, using a machine learning operations model, a compliant schedule based on the input data, the crew rules, and the equipment rules;
assigning to the compliant schedule, using the machine learning operations model, an original set of weighted values, an index value, an increment associated with the index value, and a maximum index value;
calculating an updated index value based on the index value and the increment;
calculating, according to the updated index value and using the machine learning operations model, a set of probable impacts on the compliant schedule associated with a plurality of variables,
generating, based on the set of probable impacts and using the machine learning operations model, a candidate schedule and a candidate set of weighted values;
calculating a score based on the candidate set of weighted values relative to the original set of weighted values; and
auditing the candidate schedule based on the crew rules and the equipment rules to generate an audited candidate schedule.

2. The system of claim 1, wherein the machine learning operations model comprises a candidate schedule evaluator and a cycle recursion controller, and
wherein generating the candidate schedule further comprises:
evaluating the candidate schedule according to a final condition using the candidate schedule evaluator;
detecting that the candidate schedule does not satisfy the final condition;
recursively, using the cycle recursion controller, and iteratively according to the increment, executing a set of recursive processes using the machine learning operations model, wherein the set of recursive processes comprises:
(a) generating a subsequent compliant schedule based on a previous candidate schedule, the crew rules, and the equipment rules, wherein the previous candidate schedule is associated with a previous candidate set of weighted values;
(b) assigning to the subsequent compliant schedule a subsequent set of weighted values;
(c) calculating a next index value based on the increment and at least one of the index value or the updated index value;
(d) calculating, according to the next index value, a next set of probable impacts on the subsequent compliant schedule associated with the plurality of variables;
(e) generating, based on the next set of probable impacts, a next candidate schedule and a next candidate set of weighted values;
(f) calculating a next score based on the next candidate set of weighted values relative to the previous candidate set of weighted values;
(g) evaluating the next candidate schedule according to the final condition using the candidate schedule evaluator; and
repeating the set of recursive processes until the next candidate schedule satisfies the final condition.

3. The system of claim 2, further comprising:
selecting a final candidate schedule when the final condition is satisfied, wherein the final condition comprises a state selected from a group consisting of the next score approaching an extreme relative to one or more previous scores, and the next index value reaches or exceeds the maximum index value.

4. The system of claim 1, wherein the candidate set of weighted values comprises:
a compliance-based weighted value based on the crew rules and the equipment rules, and a balance-based weighted value based on the set of the balance settings.

5. The system of claim 1, wherein the candidate set of weighted values comprises:
a compliance-based weighted value based on the set of probable impacts provoked by the candidate schedule relative to the crew rules and the equipment rules, and
a balance-based weighted value based on the set of probable impacts provoked by the candidate schedule relative to the balance settings.

6. The system of claim 2, wherein auditing the candidate schedule further comprises:
detecting a compliance violation within the candidate schedule;
transmitting to the machine learning operations model the compliance violation and an instruction to repeat the set of recursive processes.

7. The system of claim 1, further comprising:
presenting the audited candidate schedule on a display; and
transmitting the audited candidate schedule to a scheduling application.

8. The system of claim 1, wherein the instructions when executed cause the one or more processors to perform further process steps, comprising:
receiving real-time data comprising an active schedule, wherein the active schedule comprises an active crew schedule, an active equipment schedule, and an active transport schedule;
flagging a component and a component value associated with the active schedule based the crew rules and the equipment rules, wherein flagging comprises identifying one or more of a regulatory violation, a proximity value, and a trend associated with the component value relative to an applicable regulation in the compliance library;
generating a compliance notice comprising the component, the component value, and the applicable regulation;
generating a compliance report comprising the component, the component value, and the applicable regulation; and
transmitting at least one of the compliance notice or the compliance report to one or more personnel associated with the active schedule.

9. The system of claim 1, wherein the instructions when executed cause the one or more processors to perform further process steps, comprising:
training a generative artificial-intelligence model trained using a corpus of industry-specific human language SPEC human language and image data SPEC; and
receiving a textual input using a user interface, wherein the textual input comprises one or more of a text message and a voice command,
wherein the process step of receiving input data further comprises processing the textual input using the generative artificial-intelligence model, such that the input data comprises one or more items of data based on the textual input, and
wherein the process step of generating the compliant schedule is based on the textual input.

10. The system of claim 9, wherein the instructions when executed cause the one or more processors to perform further process steps, comprising:
searching the audited candidate schedule for one or more items of information responsive to the textual input; and
generating a message using the generative artificial-intelligence model, wherein the message comprises the one or more items of information.

11. The system of claim 9, wherein the instructions when executed cause the one or more processors to perform further process steps, comprising:
training the generative artificial-intelligence model trained using a corpus of industry-specific image data; and
receiving an image input captured using a camera,
wherein the process step of receiving input data further comprises processing the image input using the generative artificial-intelligence model, such that the input data comprises one or more items of image data based on the image input, and
wherein the process step of generating the compliant schedule is based on the image input.
